(19) United States
(12) Patent Application Publication
(10) Pub. No.: US 2014/0119691 A1
(43) Pub. Date: May 1, 2014

(54) OPTO-COUPLER WITH LIGHT GUIDE

(71) Applicant: AVAGO TECHNOLOGIES GENERAL IP (SINGAPORE) PTE. L, Singapore (SG)

(72) Inventors: Gary Tay, Singapore (SG); Premkumar Jeromerajan, Singapore (SG); Gopinath Maasi, Singapore (SG)

(73) Assignee: Avago Technologies General IP (Singapore) Pte. Ltd., Singapore (SG)

(21) Appl. No.: 13/663,041

(22) Filed: Oct. 29, 2012

(51) Int. Cl. G02B 6/42

(52) U.S. Cl. 385/31

(57) ABSTRACT

An optoelectronic device is disclosed. The optoelectronic device may be employed as a single or multi-channel opto-coupler that electrically isolates one circuit from another circuit. The opto-coupler may include one or more light guides that facilitate an efficient transfer of optical signals from a light source to a light detector.

### FIELD OF THE DISCLOSURE

The present disclosure is generally directed toward optoelectronic devices and, in particular, opto-coupling devices.

### BACKGROUND

In electronics, an opto-coupler, also referred to as an opto-isolator, photocoupler, or optical isolator, is an optoelectronic device designed to transfer electrical signals by utilizing light waves to provide coupling with electrical isolation between its input and output. One goal of an opto-coupler is to prevent high voltages or rapidly changing voltages on one side of the circuit from damaging components or distorting transmissions on the other side.

A typical opto-coupler includes a light source, such as a Light Emitting Diode (LED), a photodetector, and an insulation medium. As the name suggests, an optical path needs to be created between the LED and photodetector via the insulation medium. This is traditionally done by using an optically-transparent material such as silicone to create the light path. The insulation medium not only acts to allow the transmission of light from the LED to the photodetector, but the insulation medium also electrically insulates the input and output sides of the circuit.

Certain applications have stringent design rules regarding the true distance between the high voltage and low voltage side of the circuitry. In opto-couplers, the true distance between the high voltage side and low voltage side of the Printed Circuit Board (PCB) translates to be the closest metal-to-metal distance within the opto-coupler. This distance is often referred to as the opto-coupler's Distance Through Insulation (DTI), creepage distance, or the like. It should be appreciated that the DTI of opto-couplers is an important design consideration/constraint.

Problematically, as the DTI increases, the optical efficiency of the opto-coupler decreases. Specifically, the insulation medium traditionally used to create the light path is lossy, which means that not all of the light emitted by the light source is detected at the photodetector. Consequently, there are two competing design objectives for opto-couplers: (1) increase DTI and (2) maximize optical efficiency.

### SUMMARY

It is, therefore, one aspect of the present disclosure to provide an improved opto-coupler design that overcomes and addresses the above-mentioned issues. In particular, embodiments of the present disclosure provide an opto-coupler with a light guide situated between the light source and the light detector. In some embodiments, the opto-coupler is provided with a light source, a light detector, and a light guide connecting the light source to the light detector. In some embodiments, the light guide does not conduct electricity in much the same way to traditional insulation materials. However, the light guide is a much more efficient mechanism to transfer light from the light source to the light detector.

Accordingly, the utilization of a light guide in connection with an opto-coupler helps to simultaneously increase the DTI of the opto-coupler while maintaining high light-coupling efficiencies between the light source and light detector. Alternatively, the need for higher power light sources and/or more sensitive light detectors can be avoided if the DTI is kept at a normal distance. Specifically, the utilization of a light guide helps to increase the opto-couplers light coupling performance and, therefore, eliminates the need for more expensive light sources and/or light detectors.

In some embodiments, a multi-channel opto-coupler is provided where one, two, three, four or more channels in the opto-coupler have a light guide situated between a light source and light detector of each channel. Embodiments of the present disclosure also contemplate the possibility that a single channel may comprise one, two, three, or more light guides depending upon design considerations and the like. The use of light guides for a multi-channel opto-coupler also helps to minimize cross-talk between the channels. In some embodiments, the multi-channel opto-coupler may have every channel communicating in the same direction (e.g., unidirectional) or some channels communicating in different directions (e.g., bi-directional).

In some embodiments, a high linearity analog opto-coupler is provided. The high linearity analog opto-coupler may comprise a light guide having a back substrate emitting light source attached thereto. The back substrate emitting light source may be connected on the light guide, which may also be connected to one or more light detectors. In some embodiments, the light guide carries light from the back substrate emitting light source to at least two light detectors. Signals received at one of the detectors can be compared to and may potentially validate signals received at another of the detectors.

Any type or configuration of opto-coupler may benefit from the use of light guides as disclosed herein. As one non-limiting example, a co-planar opto-coupler may employ one or more light guides to help increase its optical coupling efficiency while also increasing DTI. As another non-limiting example, a face-to-face opto-coupler may employ one or more light guides.

The present disclosure will be further understood from the drawings and the following detailed description. Although this description sets forth specific details, it is understood that certain embodiments of the invention may be practiced without these specific details. It is also understood that in some instances, well-known circuits, components and techniques have not been shown in detail in order to avoid obscuring the understanding of the invention.

### BRIEF DESCRIPTION OF THE DRAWINGS

The present disclosure is described in conjunction with the appended figures, which are not necessarily drawn to scale:

FIG. 1 is a cross-sectional view of a first opto-coupler configuration in accordance with embodiments of the present disclosure;

FIG. 2 is a top view of a multi-channel opto-coupler configuration in accordance with embodiments of the present disclosure;

FIG. 3A is a top view of a second opto-coupler configuration in accordance with embodiments of the present disclosure;

FIG. 3B is a side view of the opto-coupler configuration depicted in FIG. 3A;

FIG. 4 is a cross-sectional view of a third opto-coupler configuration in accordance with embodiments of the present disclosure;

FIG. 5 is a flow chart depicting a method of manufacturing an opto-coupler in accordance with embodiments of the present disclosure;

FIG. 6A is a cross-sectional side view of a substrate-based opto-coupler in accordance with embodiments of the present disclosure; and

FIG. 6B is a top view of the substrate-based opto-coupler depicted in FIG. 6A without a mold compound provided thereon.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

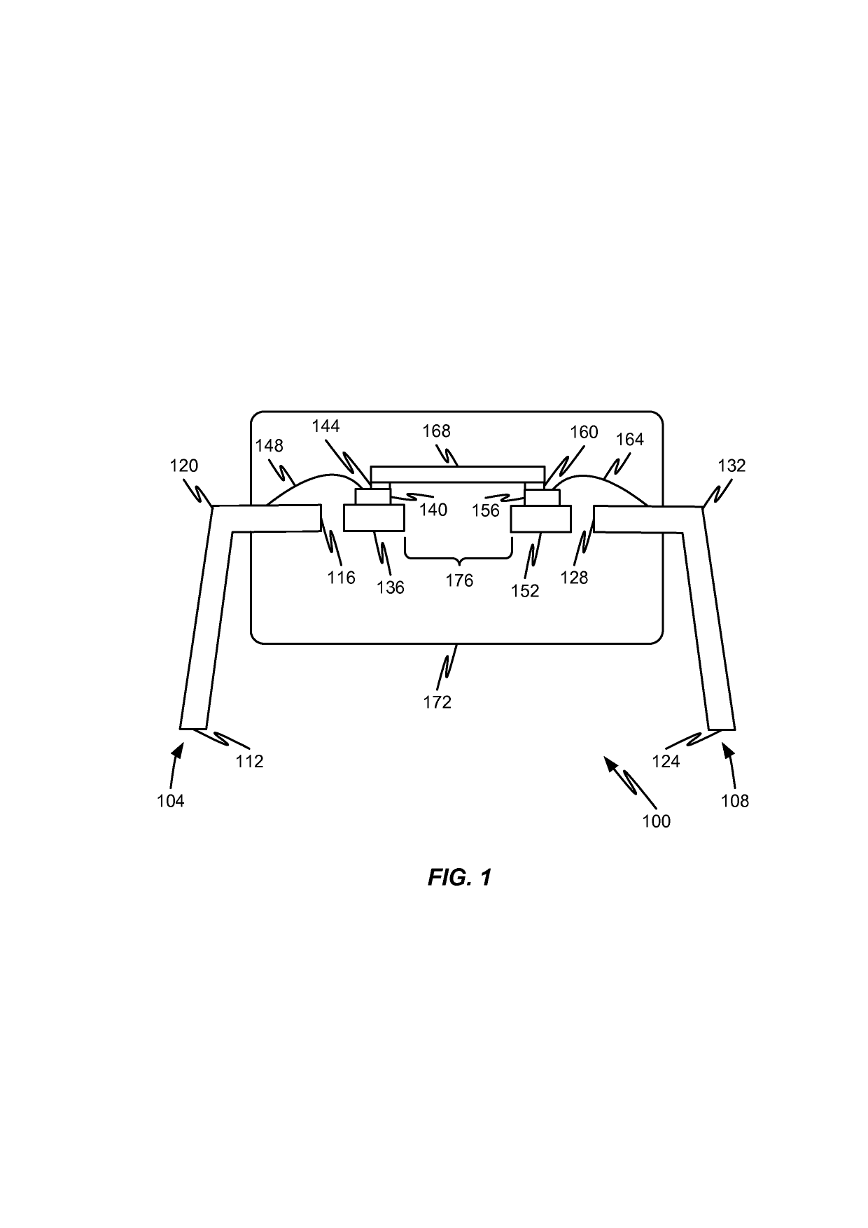

As can be seen in FIGS. 1-4, various configurations of optoelectronic devices, opto-couplers, and intermediate opto-coupler configurations are depicted and described. Although some of the opto-couplers depicted in the figures correspond to opto-couplers at intermediate stages of manufacturing, one of ordinary skill in the art will appreciate that any of the intermediate products described herein can be considered an opto-coupler. In other words, one or more of the optoelectronic devices may be employed as opto-couplers or as components within a coupling system. In some embodiments, the opto-coupler devices described herein may be incorporated into any system which requires current and/or voltage monitoring, but is susceptible to transients. In some embodiments, the coupling system in which the opto-coupler devices described herein is rated to operate at about 5kV, 10kV, or more. Stated another way, the input side (e.g., a high-voltage side) of the opto-coupler device may be directly connected to a 5kV, 10kV, 15kV or greater source without damaging the opto-coupler device or any electronic devices attached to the output side (e.g., a low-voltage side) of the opto-coupler device. Accordingly, the coupling system which employs the opto-coupler devices disclosed herein may be configured to operate in high-voltage or high-current systems but may also be configured to separate the high-voltage or high-current systems from a low-voltage or low-current system.

Referring initially to FIG. 1, a first configuration of an opto-coupler 100 will be described in accordance with at least some embodiments of the present disclosure. The opto-coupler 100 may comprise an input side 104 and an output side 108 that are separated by an isolation gap 176. The isolation gap 176 may correspond to the shortest linear distance between electrically conductive components of the input side 104 and the output side 108.

The input side 104 may be configured for connection to a circuit whose current and/or voltage is being measured and the output side 108 may be configured for connection to measurement and/or control circuitry. The isolation gap 176 is provided to electrically insulate the currents/voltages at the input circuit from the output circuit.

The input side 104 and output side 108 may each comprise one or more electrically conductive leads. The cross-sectional view of FIG. 1 shows a single lead on the input side 104 and output side 108, but those of ordinary skill will appreciate that both sides of the opto-coupler 100 may have more than one lead. In some embodiments, the leads of the input side 104 and output side 108 may be initially provided as a sheet of conductive material having portions removed therefrom to establish discrete conductive elements or features. The conductive elements of the leadframe including the leads of the input side 104 and output side 108 may be constructed of metal (e.g., copper, silver, gold, aluminum, steel, lead, etc.), graphite, and/or conductive polymers.

The lead of the input side 104 comprises a first end 112 and second end 116 with a bend or fold 120 therebetween. The first end of the input lead 112 may be configured to interface with external circuitry, such as a Printed Circuit Board (PCB) or the like. The second end of the input lead 116 may terminate inside a mold material 172 that encapsulates and protects the optical components of the opto-coupler 100. The bend 120 between the first end of the input lead 112 and the second end of the input lead 116 may occur outside the mold material 172 thereby enabling the opto-coupler 100 to be mounted on a PCB or inserted into thru holes of a PCB.

Similar to the input side 104, the lead of the output side 108 comprises a first end 124 and second end 128 with a bend or fold 132 therebetween. The first end of the output lead 124 may be configured to interface with external circuitry, such as a PCB or the like. The second end of the output lead 128 may terminate inside the mold material 172. The bend 132 between the first end of the output lead 124 and the second end of the output lead 128 may be symmetrical to the bend 120 on the input side 104.

In some embodiments, the bends 120, 132 and the length of the leads extending beyond the mold material 172 may be adjusted to suit the particular type of device to which the opto-coupler 100 will be connected. In other words, although embodiments of the present disclosure show the leads as having a specific configuration (e.g., thru-hole configurations), it should be appreciated that the leads or relevant sections protruding from the mold material 172 may comprise any type of known, standardized, or yet-to-be developed configuration such as straight-cut leads, J leads, SOJ leads, gullwing, reverse gullwing, etc.

In some embodiments, the optical components of the opto-coupler may be mounted directly on the leads, which extend out of the mold material 172. In some embodiments, a first mounting section 136 may be provided on a lead of the input side 104. The first mounting section 136 may be part of a lead that extends outside the mold material 172 or it may be contained within the mold material 172. The first mounting section 136 may be configured to accommodate a light source 140. In some embodiments, the first mounting section 136 may be designated or designed to have the light source 140 mounted, welded, adhered, glued, fixed, or otherwise placed thereon. The first mounting section 136 does not necessarily have to be a part of the leadframe, but instead can be part of some other structure in the opto-coupler. In the depicted embodiment, the first mounting section 136 is substantially co-planar with the second end of the input lead 116 and the second end of the output lead 128.

Similar to the input side 104, the output side 108 may also comprise a structure on which a light detector 156 can be received. Specifically, a second mounting section 152 may be provided may be designated or designed to have the light detector 156 mounted, welded, adhered, glued, fixed, or otherwise placed thereon. The second mounting section 152 does not necessarily have to be a part of the leadframe, but instead can be part of some other structure in the opto-coupler. In the depicted embodiment, the second mounting section 152 is substantially co-planar with the first mounting section 136, the second end of the input lead 116, and the second end of the output lead 128. It is particularly efficient to build this type of co-planar opto-coupler with a leadframe that is initially provided in a sheet, since the sheet is initially flat and all of the leads and mounting sections are already in a common plane.

The light source 140 and light detector 156 may be used to transmit signals across the isolation gap 176 in the form of optical signals. As will be discussed in further detail herein, a light guide 168 may facilitate the transmission of optical signals from the light source 140 to the light detector 156. Utilization of the light guide 168 to carry the optical signals may enable a larger isolation gap 176 without sacrificing optical efficiencies.

In some embodiments, the light guide 168 corresponds to one or more of a casted epoxy, a clear epoxy, a casted silicone, a clear silicone, a light guide film, a polymer, an optical fiber, a plurality of optical fibers, combinations thereof, or the like. The light guide 168 can be treated or specifically manufactured to facilitate an efficient transfer or light from the light source 140 to the light detector 156. As one example, the areas where the light guide 168 will interface with the light source 140 and/or light detector 156 may be roughened, scratched, and/or treated to facilitate light diffusion. As another example, possibly in combination with the light diffusion treatments, the light guide 168 may be polished to create a reflective inner surface across the length of the light guide 168. As another example, possibly in combination with the light diffusion treatments and/or polish treatments, the light guide 168 may have its ends treated to facilitate more light reflection, thereby causing light travelling through the light guide 168 to be trapped and send back into the light guide 168 rather than escaping out of its ends. Depending upon the treatments provided to the light guide 168, it may be possible to achieve less than 10% optical losses from the light source 140 to the light detector 156.

The light guide 168 may also be designed to efficiently and reliably connect with the light source 140 and/or light detector 156. As an example, the light guide 168 may have an outer surface finish that is designed to have better adhesion with the light source 140 and/or light detector 156.

In some embodiments, the signals transmitted across the isolation gap 176 may correspond to electrical signals that are converted into optical signals by the light source 140. The light source 140 emits light through the light guide 168 to the light detector 156. The light detector 156 then converts the optical signals back into electrical signals for transmission across one or more of the leads of the output side 108.

In some embodiments, the light source 140 may be a single light source or a plurality of light sources. Likewise, the light detector 156 may be a single detector component or multiple detector components.

In some embodiments, the light source 140 corresponds to a surface mount LED, a traditional LED (e.g., with pins for thru-hole mounting), an array of LEDs, a laser diode, or combinations thereof. The light source 140 is configured to convert electrical signals (e.g., current and/or voltage) from one or more leads of the input side 104 into light. The light emitted by the light source 140 may be of any wavelength (e.g., either in or out of the visible light spectrum).

In some embodiments, the light detector 156 corresponds to device or collection of devices configured to convert light or other electromagnetic energy into an electrical signal (e.g., current and/or voltage). Examples of a suitable light detector 156 include, without limitation, a photodiode, a photoresistor, a photovoltaic cell, a phototransistor, an Integrated Circuit (IC) chip comprising one or more photodetector components, or combinations thereof. Similar to the light source 140, the light detector 156 may be configured for surface mounting, thru-hole mounting, or the like.

In some embodiments, one surface of the light source 140 is an anode and another surface of the light source 140 is a cathode. One of the anode and cathode may be electrically connected to the first mounting section 136 and the other of the anode and cathode may be electrically connected to a different lead via a wire 148. By creating a potential between the anode and cathode of the light source 140, the light source 140 may be configured to emit light of a predetermined wavelength. It should be appreciated that not every lead on the input side 104 needs to be connected either physically or electrically with the light source 140.

Like the light source 140, the light detector 156 may be mounted on the second mounting section 152 (e.g., corresponding to one of the leads of the output side 108) and may be electrically connected to another lead via a wire 164.

In some embodiments, the light guide 168 may be directly connected to both the light source 140 and the light detector 156. In other embodiments, the light guide 168 may be connected to the light source 140 via coupling 144 and to the light detector 156 via coupling 160. The couplings 144, 160 may correspond to any type of optically transparent material that facilitates or promotes a mechanical/physical connection between the light guide 168 and the light source 140 and the light guide 168 and the light detector 156. More specifically, the couplings 144, 160 may comprise one or more of a transparent glue, epoxy, and silicone. As a non-limiting example, one or both couplings 144, 160 may correspond to a clear epoxy that is curable (e.g., thermally curable, UV curable, chemically curable, etc.), a clear adhesive tape, or the like. During manufacture, the light source 140 and light detector 156 may be connected to their respective mounting sections and then the light guide 168 may be connected to the light source 140 and light detector 156 with the couplings 144, 160. Thereafter, the couplings 144, 160 may be cured, thereby substantially fixing the relative positions of the light source 140, the light detector 156, and the light guide 168.

The co-planar configuration of the opto-coupler 100 helps to create a low-profile package. Specifically, it can be seen that the top surfaces of the leads and the mounting sections 136, 152 may be co-planar. The bottom surface of the light source 140 may be proximate the top surface of the first mounting section 136 and the bottom surface of the light detector 156 may be proximate the top surface of the second mounting section 152. The top surfaces of the light source 140 and light detector 156 may also be substantially co-planar and proximate the bottom surface of the light guide 168. The length of the light guide 168 may be larger than the isolation gap 176. However, the overall height of the opto-coupler 100 is kept to a minimum.

Another advantage of using the light guide 168 is that the need for multiple mold materials can be avoided. Specifically, since the light guide 168 effectively creates the optical path between the light source 140 and light detector 156, there is no need for a transparent mold material between the light source 140 and light detector 156. Rather, a single mold material 172 can be used to encapsulate and protect the optical components of the opto-coupler 100 rather than the traditional double-mold configurations where a transparent or translucent inner mold is used to create the optical path and the inner mold is further encapsulated by an opaque outer mold. The single mold material 172 may correspond to a transparent, translucent, or opaque material thanks to the use of the light guide 168. Additionally, the single mold material 172 may comprise non-conductive or insulative properties. Suitable types of materials that may be used as the single mold material 172 include, without limitation, epoxy, silicone, a hybrid of silicone and epoxy, phosphor, a hybrid of phosphor and silicone, an amorphous polyamide resin or fluorocarbon, glass, any polymer or combination of polymers, any malleable or formable opaque material, or combinations thereof. The single mold material 172 may be manufactured using extrusion, machining, micro-machining, molding, injection molding, or a combination of such manufacturing techniques.

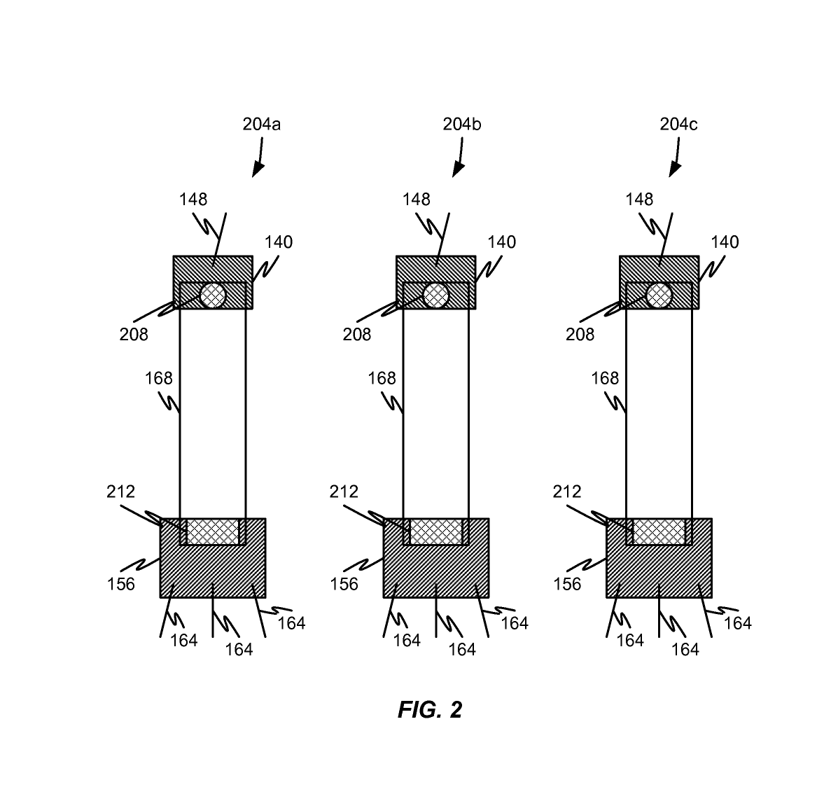

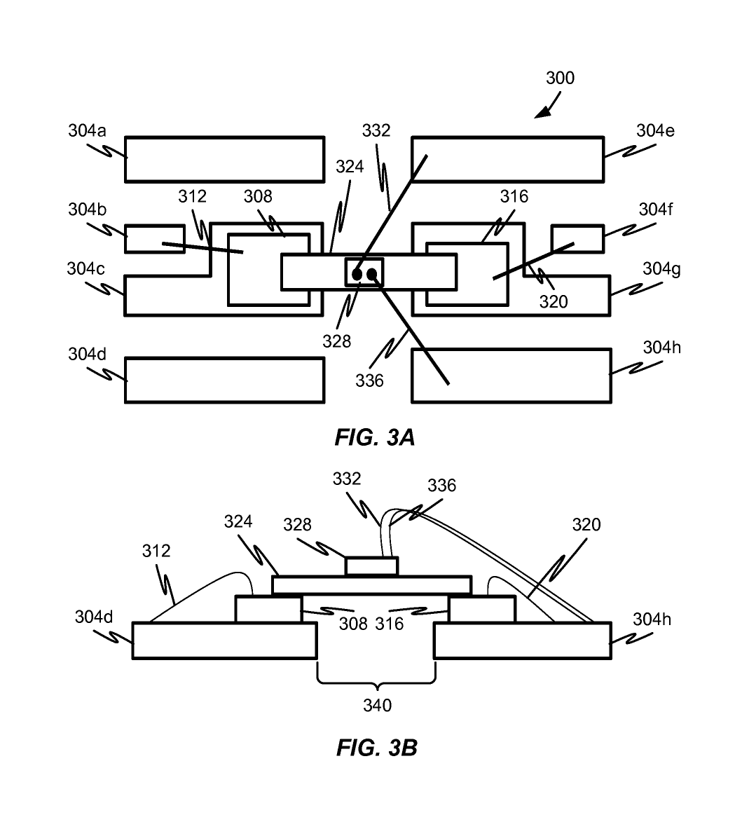

With reference now to FIG. 2, a multi-channel opto-coupler configuration will be described in accordance with at least some embodiments of the present disclosure. It should be noted that the view of the opto-coupler in FIG. 2 does not show the wires 148, 164 as being covered by a mold material as in FIG. 1, but it should be appreciated that such a configuration is possible and likely. The view of FIG. 2 is simply intended to show the multiple channels of an opto-coupler without the mold material being shown. It should be appreciated, however, that the multi-channel opto-coupler may comprise multiple channels 204a, 204b, 204c within the single mold material 172. In some embodiments, each channel 204a, 204b, 204c may be created by different input and output lead pairs. In some embodiments, each channel 204a, 204b, 204c may transmit data in the same direction (unidirectional multi-channel opto-coupler) while in other embodiments, some channels may transmit data in different directions (bi-directional multi-channel opto-coupler). One, some, or all of the channels of the multi-channel opto-coupler may have a co-planar configuration, as is shown in FIG. 1. Additionally or alternatively, one, some, or all of the channels of the multi-channel opto-coupler may be configured according to other embodiments described herein, such as those shown in FIGS. 3A, 3B, or 4. Furthermore, although FIG. 2 shows the opto-coupler as having three channels, it should be appreciated that a multi-channel opto-coupler may comprise a greater or lesser number of channels (e.g., two, three, four, five, . . . , twenty, etc.) without departing from the scope of the present disclosure.

Each channel 204a, 204b, 204c may comprise a light source 140 and light detector 156 that are connected via a light guide 168. The light source 140 may be configured to emit light from its entire top surface or, as shown in the depicted embodiment, the light source 140 may have a light-emitting area 208 that is smaller than the entire top surface. Similarly, the light detector 156 may comprise a light-sensitive area 212 that is smaller than the entire top surface of the light detector 156. As a more specific example, the light detector 156 may correspond to an IC chip and the light-sensitive area 212 may correspond to an area where one or more photodetectors are positioned on the top of the IC chip.

With reference now to FIGS. 3A and 3B, another possible configuration of an opto-coupler 300 will be described in accordance with at least some embodiments of the present disclosure. This particular configuration may correspond to a high linearity analog coupler that includes a back substrate emitting light source. The opto-coupler 300 may comprise a leadframe having a plurality of leads 304a-h. In the depicted embodiment, the leadframe comprises eight leads 304a, 304b, 304c, 304d, 304e, 304f, 304g, 304h. However, it should be appreciated that an opto-coupler 300 may be provided with a greater or lesser number of leads. For example, a multi-channel high linearity analog coupler may comprise a greater number of leads than depicted.

Each of the leads 304a-h may extend into a mold material and out of a mold material that is eventually placed around the optical components of the opto-coupler 300. Some of the leads may be primarily provided to carry electrical signals to/from the optical components whereas other leads may be provided with a larger surface area to facilitate mounting of an optical component thereto. In the depicted embodiment, the third lead 304c and seventh lead 304g are depicted as having enlarged areas that can be used for receiving and mounting light detectors 308, 316 thereto. More specifically, the third lead 304c may comprise a mounting area configured to receive a first light detector 308. In some embodiments, the third lead 304c may also be configured to carry electrical current from the first light detector 308. In other embodiments, a wire 312 may connect the first light detector 308 to a different lead (e.g., the second lead 304b) to carry electrical current from the first light detector 308. In some embodiments, the first light detector 308 may be used to provide electrical signals to output side circuitry.

Leads on the input side may be separated from leads on the output side by an isolation gap 340. The isolation gap corresponds to the DTI or creepage distance of the opto-coupler 300 and the light guide 324 may be used to facilitate the transmission of light from the light source 328 to the light detector 308 across the isolation gap 340.

The opposite side of the opto-coupler 300 (e.g., the input side) may have the seventh lead 304g configured with an extended mounting section to receive the second light detector 316. Similar to the third lead 304c, the seventh lead 304g may be configured to carry electrical current from the second light detector 316 or a wire 320 may connect the second light detector 316 to a different lead on the input side (e.g., the sixth lead 304f), which carries the electrical current from the second light detector 316.

The first light detector 308 and second light detector 316 may be connected by a light guide 324 that extends between the light-detecting areas of the light detectors 308, 316. In some embodiments, the light guide 324 may be similar or identical to the light guide 168 depicted in FIG. 1.

A light source 328 may also be connected to the light guide 324. In some embodiments, the light source 328 is connected to the light guide 324 at a location between the first light detector 308 and the second light detector 316. A first wire 332 may connect an anode of the light source 328 to one lead (e.g., the fifth lead 304e) while a second wire 336 may connect a cathode of the light source 328 to another lead (e.g., the eighth lead 304h). The light source 328 may correspond to a back substrate emitting LED and the light-emitting surface of the light source 328 may be directly attached to the top surface of the light guide 324. The attachment of the light source 328 to the light guide 324 may be direct or it may be facilitated by a transparent adhesive or the like.

The multiple light detectors 308, 316 are provided so that signals on the output side (e.g., signals emitted by the first light detector 308 in response to detecting light from the light source 328) can be compared to signals on the input side (e.g., signals emitted by the second light detector 316 in response to detecting the same light from the light source 328). If the signals emitted by the light detectors 308, 316 are generally the same, then the opto-coupler 300 can be confirmed to be operating effectively. However, if there is a difference between the timing of signals emitted by the light detectors 308, 316, then the opto-coupler 300 may be determined to be faulty or operationally ineffective.

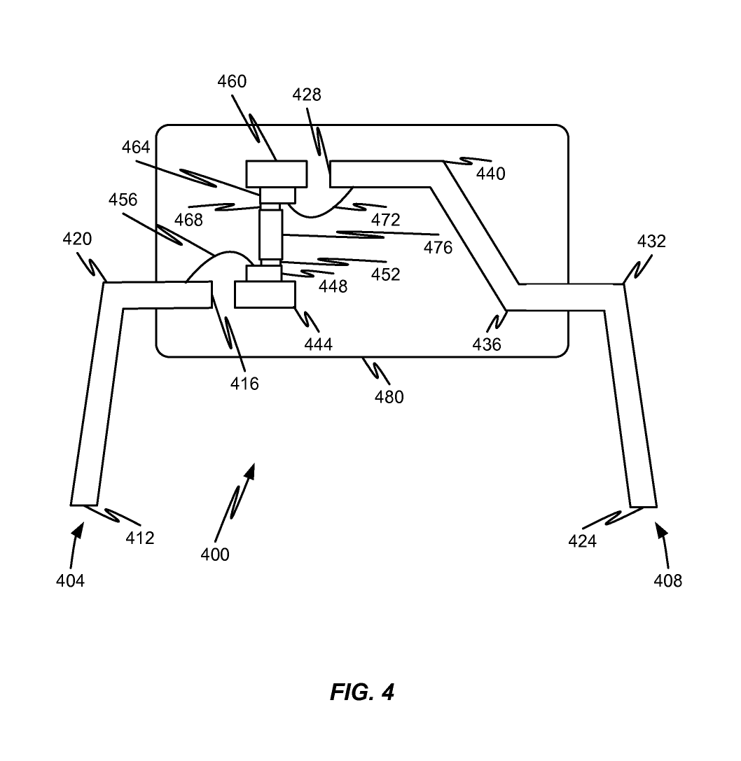

With reference now to FIG. 4, another possible configuration of an opto-coupler 400 will be described in accordance with at least some embodiments of the present disclosure. The opto-coupler 400 may correspond to a face-to-face opto-coupler, which means that the light source 464 is positioned so as to emit light directly toward the light detector 448. The opto-coupler 400 may be similar to other opto-couplers disclosed herein in that it may comprise an input side 408 and an output side 404. The output side 404 may comprise one or more leads, each having a first end 412, a second end 416, and a bend of fold 420 therebetween. The input side 408 may also comprise one or more leads, each having a first end 424 and a second end 428. The leads of the input side 408, however, may have a plurality of bends of folds 432, 436, 440 between the first end 424 and second end 428.

Although the lead(s) of the input side 408 is shown as having multiple bends, it should be appreciated that the lead(s) of the output side 404 may comprise the multiple bends and the lead(s) of the input side 408 may comprise the single bend. Stated another way, the light source 464 may be positioned above the light detector 448 or the light detector 448 may be positioned above the light source 464.

In some embodiments, the output side 404 comprises a first mounting section 444 configured to receive the light detector 448. Additionally, a wire 456 may electrically connect the light detector 448 to a lead other than the lead having the first mounting section 444. The bottom surface of the light detector 448 may be proximate to the top surface of the first mounting section 444, which may also be co-planar with the top surface of the other lead(s) on the output side.

The input side 408 may comprise a second mounting section 460 configured to have the light source 464 mounted thereto. Additionally, a wire 472 may electrically connect the light source 464 to a lead other than the lead having the second mounting section 460. In some embodiments, the second mounting section 460 is at least partially overlapping or overhanging the first mounting section 444. Furthermore, the light source 464 may be mounted to the second mounting section 460 such that a light guide 476 can be connected between the bottom surface of the light source 464 and the top surface of the light detector 448.

In some embodiments, the light guide 476 may have a first end connected to the light source 464 and a second end connected to the light detector 448. The ends of the light guide 476 may be connected directly or indirectly to the mounting sections 444, 460. More specifically, an optional coupling 452, 468 may be used to connect or adhere the ends of the light guide 476 to the mounting sections 444, 460. The light guide 476 may be similar or identical to other light guides described herein. In some embodiments, the face-to-face configuration may facilitate a more efficient light coupling because the light travels directly from one end of the light guide 476, across the length of the light guide 476, to the other end of the light guide 476 (e.g., there is no requirement for light to reflect off the inner surface walls to travel through the light guide 476 as with the co-planar configuration). One difference that may exist between the light guide 476 an other light guides described herein is that the light guide 476 may have surface treatments to enhance or promote diffusion on its ends rather than side surfaces since the ends of the light guide 476 are configured to interface with the light source 464 and light detector 448.

As with the other opto-couplers, the face-to-face opto-coupler 400 may comprise a single mold material 480 that encapsulates and protects the optical components of the opto-coupler 400. The mold material 480 may be similar or identical to other mold materials described herein.

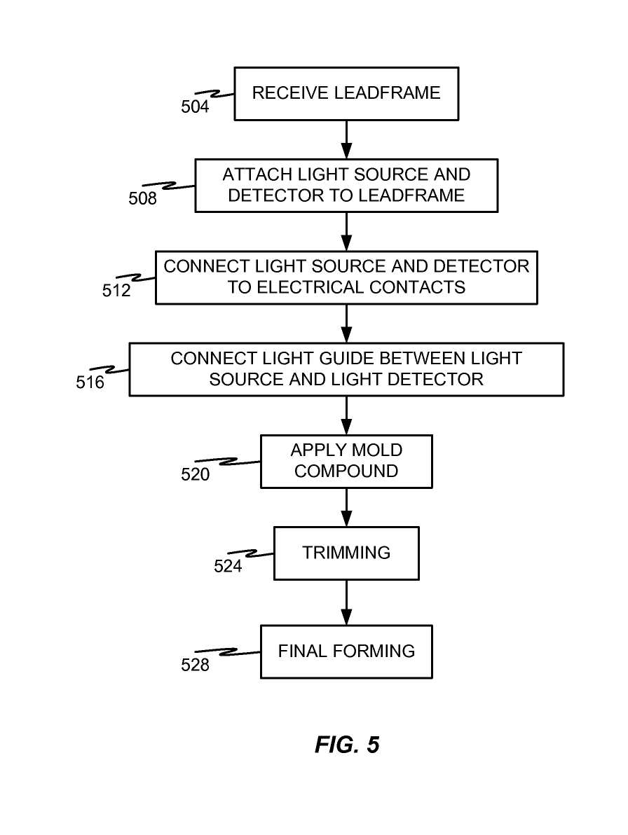

With reference now to FIG. 5, a method of manufacturing any one of the opto-couplers described herein will be discussed in accordance with embodiments of the present disclosure. The method begins when a leadframe is received (step 504). The received leadframe may comprise multiple leads, some designed for an input side and some designated for an output side. In some embodiments, the leadframe may be received in a sheet-like format with features cut therefrom to at least partially establish the lead(s) and mounting section(s) of the leadframe. As can be appreciated, the leads of the leadframe may need to be bent of formed to accommodate the specific type of opto-coupler desired. For instance, if a face-to-face opto-coupler is desired, then at least some of the leads may need to be bend or folded to facilitate the face-to-face configuration of the light source and light detector. This bending or folding may be performed at any point during the manufacturing process, but it should be noted that the leadframe may be received with or without the bends to the leads.

After the leadframe is received, the method continues by attaching the light source(s) and light detector(s) to the leadframe (step 508). In some embodiments, these optical components may be attached to the leadframe using adhesives or the like, although such a configuration is not mandatory. The light source(s) and light detector(s) may then be electrically connected to the leadframe (step 512), if this was not already inherently done by virtue of mounting the components to the leadframe. Specifically, this step may involve connecting the light source(s) and/or light detector(s) to leads of the leadframe with one or more wires.

One or more light guides may also be connected between the light source(s) and light detector(s) (step 516). It should be appreciated that the order in which steps 508, 512, and 516 are performed can vary. For example, it may be possible to connect a light guide to a light source and light detector before the combined light guide, light source, and light detector are mounted to the leadframe. As another example, it may be possible to connect the light guide to the light source and light detector prior to electrically connecting the light source and light detector to the leadframe with wires.

A mold material or compound may then be applied to the optical components and portions of the leadframe, thereby encapsulating the optical components within the mold material (step 520). As discussed above, an advantage of the present disclosure is that since a light guide is used to create the optical path between the light source and light detector, the need for multiple different mold materials is obviated. However, certain embodiments of the present disclosure may utilize more than one more material if desired.

The method continues with one or more trimming steps (step 524). In these trimming steps, the leads of the leadframe may be further defined and/or separated from one another. Furthermore, the trimming may involve removing leadframe material so as to appropriate size the leads of the lead frame to interface with a PCB, for instance.

A final forming step may then be performed (step 528) to result in the completed opto-coupler. Specifically, the finally formed or trimmed leads may be bent such that the opto-coupler is easily inserted into or mounted on a PCB or the like. The finally formed leads may be bent or folded away from the original plane of the leadframe.

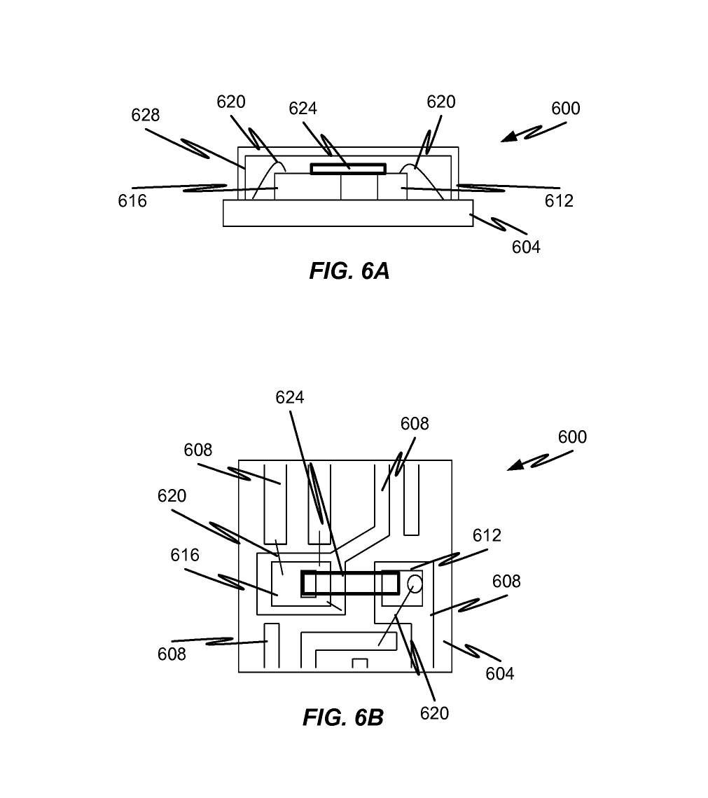

Although embodiments of the present disclosure have thus far been discussed in connection with an opto-coupler comprising a leadframe and methods of manufacturing the same, it should be appreciated that non-leadframe-based opto-couplers are also within the scope of the present disclosure. More specifically, as can be seen in FIGS. 6A and 6B, substrate-based opto-couplers may also be provided with a light guide without departing from the scope of the present disclosure.

Even more specifically, substrates 604 such as Ball Grid Array (BGA) packages, PCB packages, and the like can be used to support an opto-coupler having one or more light guides 624 as disclosed herein. With respect to manufacturing substrate-based opto-couplers 600, such as a BGA- or PCB-based opto-coupler, for example, the process flow may include the steps of (1) attaching the light source(s) 612 and light detector(s) 616 on the substrate 604 (e.g., a common substrate 604 having multiple traces 608 or conductive paths provided therein or thereon), (2) bonding the light source(s) 612 and light detector(s) 616 to one or more traces 608 of the substrate 604 with one or more wires 620, (3) attaching the light guide(s) 624 to the light source(s) 612 and light detector(s) 616 as described above, (4) molding the substrate 604 and the optical components mounted thereon with a mold compound 628 as described above, and (5) singulating the substrate 604 into one or more individual opto-couplers 600. It should further be appreciated that the order in which steps (2) and (3) are carried out can be altered or done simultaneously. Moreover, the types of light guides 624 and/or mold compounds 628 used for the substrate-based opto-coupler can be the same or identical to those used for the leadframe-based opto-couplers described herein. As one non-limiting example, the mold compound 628 may comprise a black or white non-conductive polymer. Additionally, the light source(s) 612 and light detector(s) 616 may correspond to surface mount devices that are configured to be surface mounted onto the substrate 604.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. An opto-coupler device, comprising:
at least one of a substrate and leadframe comprising one or more input leads that are electrically isolated from one or more output leads by an isolation gap;
a light source configured to emit light according to electrical signals received from the one or more input leads, wherein the light source is electrically connected to a first lead, the first lead being in the one or more input leads;
a light detector configured to detect light emitted by the light source and convert the detected light into electrical signals for transmission by the one or more output leads, wherein the light detector is electrically connected to a second lead, the second lead being in the one or more output leads; and
a light guide connected between the light source and light detector, the light guide configured to carry light from the light source to the light detector.

2. The opto-coupler device of claim 1, wherein the light guide comprises at least one of a casted epoxy, a casted silicone, a light guide film, an optical fiber, and a plurality of optical fibers.

3. The opto-coupler device of claim 1, wherein the light guide comprises a first interface area and a second interface area, the first interface area corresponding to an area of the light guide that interfaces with the light source, the second interface area corresponding to an area of the light guide that interfaces with the light detector.

4. The opto-coupler device of claim 3, wherein at least one of the first interface area and second interface area comprises a surface treatment that promotes light diffusion.

5. The opto-coupler device of claim 3, wherein the first interface area is on a first end of the light guide and wherein the second interface area is on a second end of the light guide that opposes the first end of the light guide.

6. The opto-coupler device of claim 3, wherein the first interface area and second interface area are both on a common side surface of the light guide.

7. The opto-coupler device of claim 3, wherein the first interface area is on a first side surface of the light guide and wherein the second interface area is on a second side surface of the light guide that opposes the first side surface of the light guide.

8. The opto-coupler device of claim 7, further comprising a second light detector configured to detect light emitted by the light source and convert the detected light into electrical signals for transmission by the one or more input leads, wherein the second light detector is electrically connected to a third lead, the third lead being in the one or more input leads, and wherein the second light detector interfaces with the light guide at a third interface area that is on the second side surface of the light guide.

9. The opto-coupler device of claim 8, wherein the light source comprises a back substrate emitting Light Emitting Diode (LED).

10. The opto-coupler device of claim 1, wherein the light source comprises a Light Emitting Diode (LED) and the light detector comprises a photodiode.

11. The opto-coupler device of claim 1, wherein the light guide comprises a reflective inner surface.

12. The opto-coupler device of claim 1, further comprising:
a second light source configured to emit light according to electrical signals received from the one or more input leads, wherein the second light source is electrically connected to a third lead, the third lead being in the one or more input leads;
a second light detector configured to detect light emitted by the second light source and convert the detected light into electrical signals for transmission by the one or more output leads, wherein the second light detector is electrically connected to a fourth lead, the fourth lead being in the one or more output leads; and
a second light guide connected between the second light source and second light detector, the second light guide configured to carry light from the second light source to the second light detector.

13. The opto-coupler device of claim 1, further comprising:
a single mold material that is configured to substantially enclose the light detector, the light source, and the light guide, wherein the single mold material is substantially opaque.

14. An opto-coupler, comprising:
a light guide optically coupling a light source to a light detector, wherein the light source is attached to an input side of at least one of a substrate and leadframe and wherein the light source is further configured to emit light according to electrical signals received at the input side, wherein the light detector is attached to an output side of the at least one of a substrate and leadframe and wherein the light detector is further configured to detect light emitted by the light source and convert the detected light into electrical signals, and wherein the input side is electrically isolated from the output side by an isolation gap.

15. The opto-coupler of claim 14, wherein the light source and light detector are substantially co-planar.

16. The opto-coupler of claim 14, wherein the light source and light detector are substantially face-to-face.

17. The opto-coupler of claim 14, further comprising a second light detector that is optically coupled to the light source via the light guide, wherein the light source is a back substrate emitting Light Emitting Diode (LED).

18. The opto-coupler of claim 14, further comprising a plurality of channels, at least one of the plurality of channels comprising the light guide, the light source, and the light detector.

19. A method of operating an opto-coupler, the method comprising:
receiving an electrical signal at a light source from an input lead;
converting the electrical signal into an optical signal with the light source;
emitting the optical signal from the light source into a light guide;
receiving the optical signal emitted by the light source into the light guide at a light detector;
converting the optical signal into an electrical signal with the light detector; and
transmitting the electrical signal from the light detector via an output lead, the output lead being electrically isolated from the input lead by an isolation gap.

20. The method of claim 19, wherein the light guide is configured to substantially contain the optical signal by reflecting the optical signal off one or more of its inner surfaces.
